(19) United States
(12) Patent Application Publication
(10) Pub. No.: US 2017/0318783 A1
(43) Pub. Date: Nov. 9, 2017

(54) Pet Cleaning Apparatus

(71) Applicant: Ramona Wilson, Pleasant Grove, UT (US)

(72) Inventor: Ramona Wilson, Pleasant Grove, UT (US)

(21) Appl. No.: 15/148,954

(22) Filed: May 6, 2016

(51) Int. Cl. A01K 13/00

(52) U.S. Cl. CPC A01K 13/002; A01K 13/001; A01K 13/003

(57) ABSTRACT

In an embodiment, an apparatus comprising of a base plate a plurality of bristles on the first side and a disposable layer with an interlaced network of holes having a plurality of particle collecting protrusions that align with at least the majority of the bristles of the base plate causing the disposable layer to be in close proximity of the base plate.

### BACKGROUND OF THE INVENTION

### Field of the Disclosure

The present disclosure generally relates, but not limited to, pet related products and, more specifically, to methods and apparatuses to clean a pet's coat, or any other animal that has fur and or hair, without the use of water or cleaning agents containing harsh chemicals.

### General Background

There are various methods for cleaning a pet. Often those methods involve using water or other cleaning agents on a pet.

Quite often, as relating to dogs, dog owners have not been educated with regards to the pH balance of their dog's skin and how over bathing or using the wrong cleaning agent on their dog can do serious damage to the dog's skin. The pH balance of a dog's skin is very different from a human. Human skin being acidic (5.2-6.2), and dogs skin being alkaline (5.5-7.5).

The thickness of a dog's skin is about half of what human skin is with the comparative being 3-5 cell layers for a canine, and 10-15 cell layers for a human. In summary, a dog's skin is much more sensitive than human skin and therefore can easily be damaged.

A dog's skin has a thin protective film. This is called the acid mantle. This protective coating keeps the skin healthy, creating an environment where bacteria, parasites and viruses cannot easily grow.

Unknowingly, many pet owners, including dog owners, will use a cleaning agent that is too acidic, such as human shampoo, or over wash their pet. Either one of these scenarios can strip the acid mantle, causing a disruption in the pH balance of their pet's skin. This exposes the pet's skin to the bacteria, parasites and viruses that had previously been blocked by the acid mantle.

To make matters worse, owners will increase the number of times they wash their pet because of the smell caused by a proliferation of bacteria, having created a perfect breeding ground as the skin's acid mantle was stripped and the pH level became imbalanced. Furthermore, as the pet's skin becomes more damaged, the pet will scratch at its skin, creating abrasions for the bacteria to invade.

Another method would be to brush your pet. However, this leaves behind dust and particles, and is not effective in cleaning your pet. This can be particularly harmful to pet owners who have asthma, allergies to dust, pet hair or dander, especially for those who want to keep their pets within their personal space at home.

There is also the time issue. Even if a pet owner is educated on the correct shampoo to use and how to properly bathe their pet so as to not damage their skin, traditional washing can take anywhere from 45 minutes up to 2 hours, taking into account brushing, washing, drying and clean up time.

For pet owners who have an active lifestyle with their pet, for example: hiking with their dog or other pet on a mountainside every day, getting dusty and dirty, there is currently no safe solution for effectively cleaning the dog or other pet on a daily basis.

There exists a need for an efficient and effective method for cleaning a pet that allows an owner to conveniently clean their pet as often as needed, without the need to use water or shampoo. While also collecting all the dust and particles that could be potentially harmful to the owner. There exists a need to provide a healthy environment for both pet with a cleaning apparatus that does not damage a pet's skin, disrupting the pH balance and therefore promoting bacteria growth and owner through a means to safely keep their pet clean, free from dust and particles, and therefore safe to be in their personal space.

There also exists a need for having a method to clean a pet with something that itself is clean, disposable and portable. This allows the pet owner the advantage of being able to bring something with him or her that can be used to clean their pet without making the pet wet and creating yet, a bigger mess from a wet pet. This also makes it easy to travel or spend time outdoors with their pet. The pet owner can now clean their pet before the pet gets back into the car, providing a solution for quickly and easily cleaning the pet's coat and preventing the owner's car from getting dirty and spreading particles and bugs.

There also exists a need to clean a pet without the smell of wet pet hair in the owners' home, and without the mess of pet hair being left behind in the bath or sink. This can be a potential health problem for people who are allergic to pet hair and dander. Washing a pet in the bath or sink leaves behind substantial amounts of pet hair, which can clog the drain, creating a time consuming and expensive repair. Furthermore, the pet will also shake excess water off, spraying water which contains everything that was currently in its coat, including dander, hair, particles, bugs and other else a pet may collect in its fur.

There also exists a need to be able to clean a pet's coat without aggravating or putting the pet into a distressed state. Traditional methods for cleaning a pet can be physically and mentally challenging for the pet, especially when an owner washes their pet frequently or takes their pet into a grooming salon that is full of other barking pets that are distressed. This method allows the owner to brush through their pet with an apparatus designed to feel very comfortable to the pet, gently going through the pet's fur, collecting dust and particles, without getting the pet wet or irritating the pet's skin in any way.

There also exists a need to clean a pet in a timely manner. This apparatus allows the pet owner to thoroughly clean their pet in an efficient manner in less than three minutes.

The invention of the present disclosure provides these and various other benefits and advantages.

### SUMMARY

The present disclosure provides methods and apparatuses with various benefits and advantages including, but not limited to, providing a way to clean a pet's coat with no harmful side effects to the pet, while causing no distress or aggravation to the pet. This is accomplished without the use of water or harsh cleaning agents, removing dust and particles providing a long term solution to keep a pet's coat clean. This can be achieved in any location being both portable and disposable.

The present disclosure provides for a handheld device including, but not limited to, a brush or mitt. The handheld device can be of any material known to make a handheld device, such as brushes or mitts, including, but not limited to, wood, Plexiglas™, metal, rubber, vinyl, fabric, leather, plastic and/or nylon.

The handheld device that is a brush or mitt is comprised of bristles that are fat. There can be, but not limited to, a smooth ball located at one end of each bristle. The bristles can be of any material known to make bristles including, but not limited to, plastic, metal, nylon, natural fibers and/or wood. The bristles can be short, medium or long in length to accommodate for different breeds and fur lengths.

A disposable layer that is, but not limited to, elastic in nature. The disposable layer can be made of any material known to make an interlaced network of holes including, but not limited to, rubber, elastic, string, nylon or natural fiber. The disposable layer is placed over the brush or mitt, allowing the bristles to come through the interlaced network of holes.

Attached to the disposable layer at a majority of cross-points, are pre-moistened, protruding particle collecting protrusions, such as, but not limited to, micro fibers, or any other absorbent substance. The particle collection protrusions are constructed the same length as the bristles and fit in-between the bristles, intermeshing with the bristles, as a means of removing dust and particles off of a pet's coat.

In one embodiment, the said protrusions can also be comprised of a dry variation. The dry variation consists of a fragrance and silicone. Both wet and dry protrusions can be short, medium, or long in length to accommodate for different pet breeds and fur lengths.

The disposable layer that will intermesh with the bristles comes within close proximity with the base plate and is held in place by a connection method. A connection method meaning, but not limited to, knobs, hooks, snaps, Velcro™, holes and/or other types of connections. In one embodiment, the disposable layer comes within close proximity to the handheld device and stretches around it from the corners and connects on the other side. In another embodiment, the disposable layer could be held in close proximity to the handheld device by using adhesive. In yet another embodiment, the disposable layer could be held in close proximity to the handheld device by being secured via the bristles themselves.

### DRAWINGS

The above-mentioned features and objects of the present disclosure will become more apparent with reference to the following description taken in conjunction with the accompanying drawings wherein:

FIG. 1 shows the base plate and bristles of the cleaning apparatus constructed as a handheld device.

FIG. 2 shows the base plate and bristles of the cleaning apparatus constructed to be worn as a mitt where the thumb is separate from the fingers.

FIG. 3 shows the base plate and bristles of the cleaning apparatus constructed to be worn as a mitt where the entire hand is in the same space.

FIG. 4 shows an individual bristle that would be attached to the base plate.

FIG. 5 shows an individual protrusion that would be attached to the interlaced network of holes.

FIG. 6 shows the disposable layer, having an interlaced network of holes, with particle collection protrusions in close proximity with the base plate. It also shows one embodiment of a structure, that can be, but not limited to, part of the product container that holds the disposable layers.

FIG. 7 shows the disposable layer as it is being placed in close proximity of a base plate on a mitt. It also shows one embodiment of the connection points on the back side of the mitt where the corners of the disposable layer would attach via a connection method.

FIG. 8 shows the front side of the mitt with a portion of the bristles shown. It also shows a portion of the protrusions intermeshed with the bristles as they would be when the disposable layer is in close proximity to the base plate.

### DETAILED DESCRIPTION

The present disclosure is directed to a pet cleaning method and apparatus for effective pet cleaning by, but not limited to, pet owners. The pet cleaning method and apparatus provides a healthier solution for cleaning a pet's coat as often as desired. It also provides a cleaner environment for pet owners by giving them the means to eliminate particles and dander effectively from their pet's fur. It also improves the way owners clean their pets without the use of water or cleaning agents containing harsh chemicals. It also provides a way for the pet owner to clean their pet anywhere they choose, doing so in a timely manner and with no stress or discomfort to their pet.

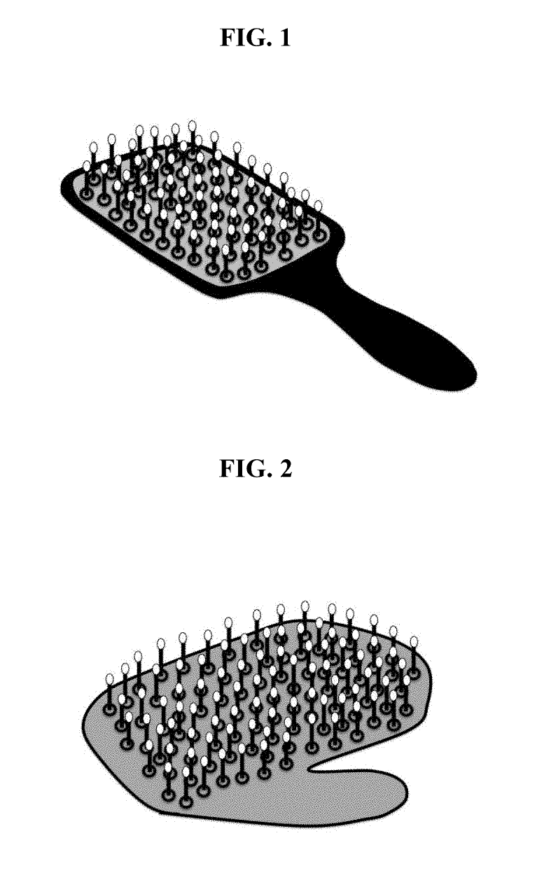

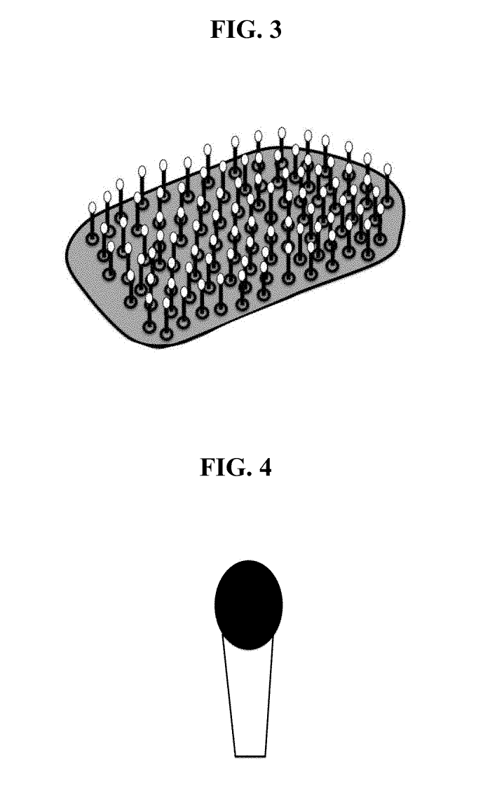

As shown in FIGS. 1, 2 and 3, the brush, and both styles of mitts, of the present invention have a plurality of bristles in the base plate on the front of each. This area can be of any material known to allow attaching brush bristles including, but not limited to, plastic, rubber, or any other flexible material that would allow some flexibility with the bristles. The brush in FIG. 1 may or may not have a handle. The handle and back side of the brush in FIG. 1 can be of any material known to make brushes including, but not limited to, plastic, composites, wood, metal, Plexiglas™, or any other durable substance. The mitts in FIG. 2 and FIG. 3 can be of any material known to make mitts, including, but not limited to, rubber, vinyl, fabric, leather, plastic, nylon or any other material that is flexible.

As shown in FIG. 4, an individual bristle is shaped as one embodiment. At the top of the bristle there is a smooth round ball, for maximum comfort. The bristle length varies to accommodate for different pets and breeds. The base of the bristle attaches to the base plate on the handheld device or either style of mitt shown in FIGS. 1, 2 and 3.

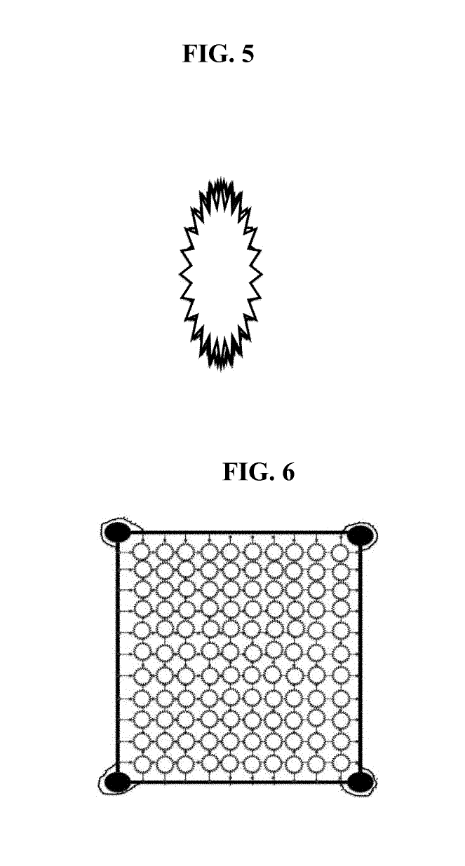

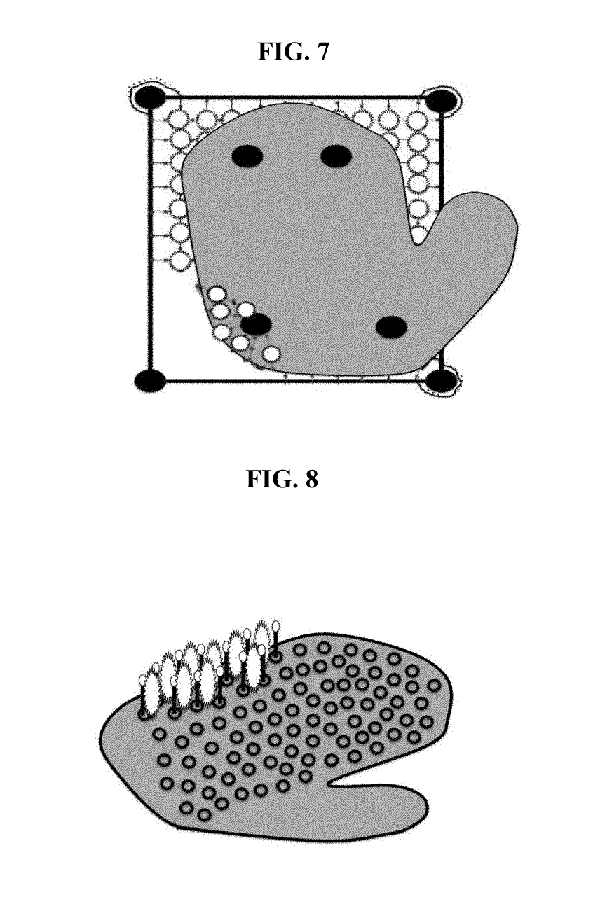

The disposable layer, as shown in FIG. 6, gets applied to the front area of the brush (FIG. 1), mitt with thumb (FIG. 2) and mitt without thumb (FIG. 3). The bristles that are contained in this front area on the handheld device will poke through the interlaced network of holes on the disposable layer and intermesh with the protrusions when pressed together, as shown in FIG. 8. The disposable layer gets placed within close proximity of the base plate on the handheld device and will attach via a connection method, as shown in FIG. 7. The disposable layer, which has an interlaced network of holes, is comprised of a plurality of protrusions. The protrusions comprise of pre-moistened micro fiber, as shown in FIG. 5, and are attached to the interlaced network of holes on the bottom of the protrusion as shown in FIG. 6. The protrusions also comprise of dry micro fiber that contain silicone and fragrance. The protrusions vary in length to accommodate different pets and various breeds and fur lengths.

When the pet owner attaches the disposable layer (FIG. 6) to the brush (FIG. 1), mitt with thumb (FIG. 2), or mitt without thumb (FIG. 3), the owner would place the apparatus onto their pet's coat. The owner would then brush their pet. The bristles on the base plate separate the pet's hair, pushing dust and particles out of the pet's coat and into the protrusions. After the owner is finished brushing their pet, the disposable layer is removed and disposed of.

What is claimed is:

1. An apparatus comprising:
a base plate having a plurality of bristles on the first side;
a disposable layer with an interlaced network of holes having a plurality of particle collecting protrusions that align with at least the majority of the bristles of the base plate causing the disposable layer to be in close proximity of the base plate.

2. The apparatus of claim 1, wherein each of the individual bristles have a smooth, round ball at the top.

3. The apparatus of claim 1, wherein the disposable layer is elastic.

4. The apparatus of claim 1, wherein the disposable layer is in close proximity to the base plate.

5. The apparatus of claim 1, wherein the protrusions release a scent and are pre-moistened.

6. The apparatus of claim 1, wherein the protrusions are pre-moistened.

7. The apparatus of claim 1, wherein the protrusions are release a fragrance and are comprised of silicone.

8. The apparatus of claim 1, wherein the second side of the base plate is attached to a handheld device.

9. The apparatus of claim 1, wherein one end of a bristle is attached to the first side of the base plate.

10. The apparatus of claim 1, wherein the base at one end of the protrusions is attached to the disposable layer.

11. A cleaning apparatus comprising:
a plurality of bristles on the first side of a cleaning apparatus;
a disposable layer with an network of holes having a plurality of particle collecting protrusions that align with at least the majority of the bristles of the first side causing the disposable layer to be in close proximity of the first side of the cleaning apparatus.

12. The apparatus of claim 1, wherein the disposable layer is elastic.

13. The apparatus of claim 1, wherein the protrusions release a scent and are pre-moistened.

14. The apparatus of claim 1, wherein the protrusions are release a fragrance and are comprised of silicone.

15. The apparatus of claim 1, wherein one end of a bristle is attached to the first side of the base plate.

16. The apparatus of claim 1, wherein the base at one end of the protrusions is attached to the disposable layer.

17. An apparatus comprising:
a base having a plurality of protrusions;
a disposable layer with an plurality of holes and a plurality of particle collecting protrusions that align with at least some of the protrusions of the base;
wherein the protrusions of the base line up with and pass through the holes of the disposable layer allowing the disposable layer to be in close proximity to the base; and
wherein the disposable layer can be discarded after use.

18. The apparatus of claim 1, wherein the disposable layer is elastic.

19. The apparatus of claim 1, wherein the protrusions release a scent and are pre-moistened.

20. The apparatus of claim 1, wherein the protrusions are release a fragrance and are comprised of silicone.
